(19) United States
(12) Patent Application Publication
(10) Pub. No.: US 2013/0252034 A1
(43) Pub. Date: Sep. 26, 2013

(54) FUEL CELLS FOR INDUSTRIAL PLANT BACKUP POWER USING STOLEN HYDROGEN

(71) Applicants: James Hu, Saratoga, CA (US); Sydney Kwan, Irvine, CA (US)

(72) Inventors: James Hu, Saratoga, CA (US); Sydney Kwan, Irvine, CA (US)

(73) Assignee: GO2 POWER, INC., Irvine, CA (US)

(21) Appl. No.: 13/426,193

(22) Filed: Mar. 21, 2012

(51) Int. Cl. H01M 16/00; H01M 8/04

(52) U.S. Cl. 429/9; 429/444

(57) ABSTRACT

A backup power system for industrial plants using purified hydrogen in critical processes. A smart valve at a hydrogen reservoir is used to steal hydrogen and divert the hydrogen to a fuel cell array providing backup power to critical processes. Before the fuel cell array comes online, backup power is provided by a battery array that can also supply backup power as the hydrogen supply is depleted.

### TECHNICAL FIELD

The invention relates to backup power systems and, in particular, to a backup power system using fuel cells.

### BACKGROUND OF THE INVENTION

In the processing of semiconductor wafers, many processing steps occur at high temperature and low pressure, such as photolithography, chemical diffusion, thin film formation, oxidation and annealing. Critical processes often take place in ovens and reactors whose temperature and pressure must be kept stable to prevent mechanical stress in wafers whose value can be many tens of thousands of dollars per wafer. When critical processes, as well as operation of critical electronics, such as computers, controllers and data storage devices, are interrupted, an expensive loss can occur. For this reason, semiconductor fabs must have reliable backup power for the situation where primary power fails and critical wafer processes are at risk.

A typical fab uses both battery and diesel backup power under control of a backup power controller. Such an arrangement is shown in U.S. Pat. No. 5,923,099 to A. Bilir. Within a second of primary power failure, backup batteries assume the load for critical processes. Within 30 seconds, sometimes longer, diesel generators can come online to supplement primary battery backup.

One of the problems with use of battery backup is that batteries require frequent monitoring for readiness and must be kept charged. Moreover, battery shelf life is limited, even where the batteries are not frequently used. Moreover, when batteries are used to supply backup power until diesel power comes online, typically after a few minutes, the batteries are considered for replacement. Fuel cells have been suggested for use with batteries as fab backup power, or in lieu of batteries, but fuel cells are more expensive than batteries. Nevertheless, with improvements in fuel cell technology and adoption of fuel cells in experimental motor vehicles and indoor vehicles, such as forklifts and carts, the cost of fuel cells is diminishing.

In the prior art, others have attempted to optimize the operating efficiency of fuel cells. For example, in U.S. Pat. No. 7,575,822 a method of operating a fuel cell is disclosed involving accounting for the cost of electricity versus the cost of fuel and then regulating fuel cell throughput accordingly. This patent recognizes that a semiconductor plant can be operated in this manner with fuel cells as primary or backup power.

An object of the invention is to integrate fuel cells into semiconductor fabs for backup power with a cost effective manner.

### SUMMARY OF INVENTION

The above object has been satisfied with a backup power system for industrial plants that uses hydrogen as a process gas, preferably high quality purified hydrogen of the kind found in semiconductor manufacturing plants, including chip plants, LED plants and hydrogen-ready plants with purified hydrogen supplies. Such high quality hydrogen is stored in tanks or reservoirs for process use. A fuel cell array is arranged to provide backup power to critical processes in the plant by borrowing or stealing hydrogen from the process gas reservoir. The hydrogen reservoir must be sufficiently large so that it can operate the fuel cell array for a specified time or condition, as well as critical processes. In this manner, hydrogen becomes part of a hydrogen economy for operation of the plant since its cost is not distinguishable from the cost of running hydrogen consuming processes. As the cost of producing hydrogen becomes less, an integration of fuel cells with hydrogen consuming processes would allow the fuel cells to provide primary electrical power with other sources providing backup power.

A power controller measures the quality of incoming line power. If the quality of A.C. power is below acceptable standards, such as having a low voltage or insufficient current, the controller generates a power failure signal that causes backup batteries to come online. At the same time fuel cells are started by diverting hydrogen from storage tanks that provide hydrogen to industrial processes that are maintained in the usual way. After a short time of running the industrial plant on backup batteries, the plant load is shifted to the fuel cells so long as hydrogen is available. Primarily, critical processes receive fuel cell power in order to conserve hydrogen. Other power needs can be met with diesel generators or other backup systems.

### DESCRIPTION OF THE DRAWINGS

FIG. 1 is a plan view of a backup power system for an industrial plant in accordance with the invention.

### DESCRIPTION

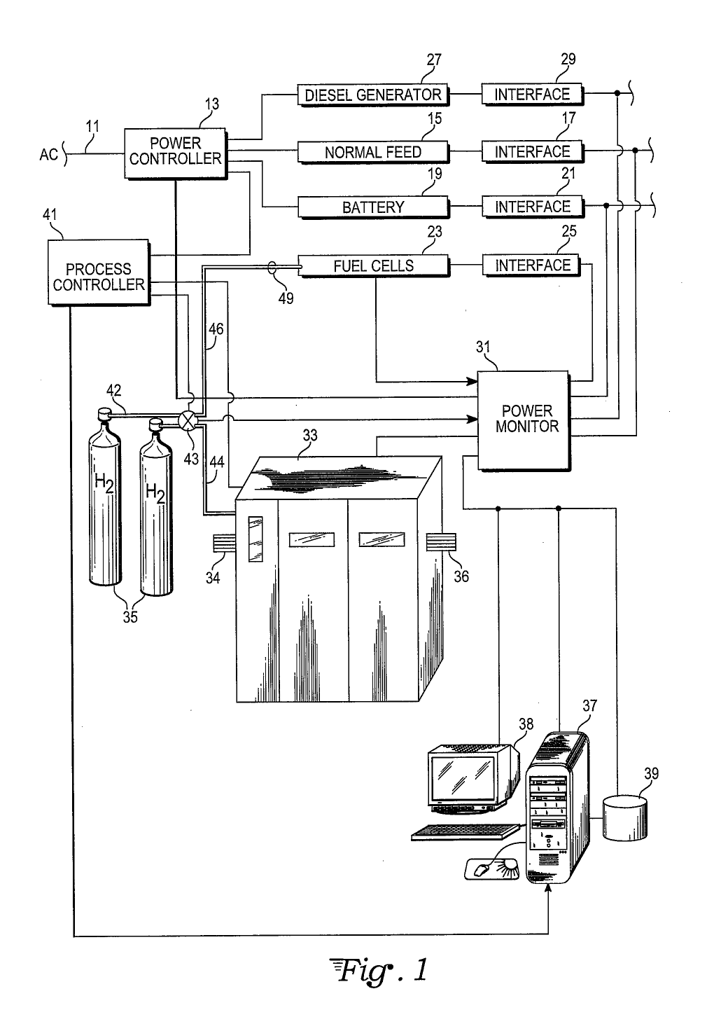

With reference to FIG. 1, an industrial plant is symbolized by an automated machine 33 for processing semiconductor wafers 34. Such processing occurs using many different machines that perform diverse functions in the plant. For purposes of simplicity, only one machine 33 is shown that may receive wafers 34 for deposition of one or more thin films and then exit the machine in wafer stack 36. Thin film deposition involves processes that have critical parameters, such a temperature and such processes are deemed to be critical processes because the operation cannot be interrupted without damage to wafers. Moreover, certain ovens and reactors must be maintained at certain temperatures and pressure conditions to avoid damage to wafers and are included among factory critical processes, even when not processing substrates. For example, in deposition of thin films by chemical vapor deposition, the preferred temperature for deposition is usually above 750° C. at the substrate. If the substrate falls below the preferred temperature, deposition may occur elsewhere in the reactor, for example in a showerhead or a liner plate, thereby contaminating the reactor. Similarly, deposition occurs under very low pressure conditions and so vacuum pumps must continue to run during deposition. For this reason, reactors and ovens must be kept under appropriate power and are deemed critical processes.

During normal operating conditions A.C. power from a utility arrives at an industrial plant at a power controller 13 on power line 11. The controller monitors power quality by measurement of voltage and current; as well as other parameters. Normal limits for voltage and current are established by calibration. Normal power is sent through a normal feed path 15 to an interface 17 which'converts normal power, if necessary, to appropriate power for particular equipment, such as machine 33. Very frequently the interface 17 will be distributed within various pieces of equipment. For example, a reactor may have an A.C. to D.C. converter for providing a desired level of D.C. voltage and current for operations. Power sent to a machine 33 and power within machine 33 is reported to a process monitor 31 that is part of a computer 37 that logs data for storage on a disc 39 and displayed on a video display 38 for an operator. In the event that power arriving at the industrial plant is outside of normal limits, a power failure signal is generated by the power controller 13. This signal goes to battery array 19, diesel generator 27, as well as blocking the normal feed path 15 using power controller 13. Battery array 19 is adequate for supplying backup power to critical processes through interface 21 for several hours.

The power failure signal is also reported to process controller 41 which reports the condition to computer 37. Process controller 41 uses the power failure signal to operate a smart meter 43 connected to hydrogen reservoir 35. The hydrogen reservoir 35 sends purified hydrogen gas to smart meter. 43 via pipe 42 where the hydrogen is diverted, or stolen, for use in fuel cells 23.

The smart meter 43 has the capability of diverting gas flow to the fuel cells via pipe 46 on command of the power controller 13, as well as continuously monitoring flow rates to the fuel cells and to industrial processes in equipment 33 fed via pipe 44, then reporting usage to process monitor 31 which, in turn, reports to computer 37. The fuel cells require a few minutes to develop full voltage and adequate current, as reported to a process monitor 31 and computer 37.

When full voltage and adequate current for backup is achieved, computer 37 sends a signal to the process controller 41 which then notifies the power controller 13 to shut down battery 19, allowing fuel cells 23 to provide power through interface 25 to machine 33 through interface 25. A typical industrial plant may require as much as 2 kW of backup power, sometimes more, for critical processes. To generate 1 kW a fuel cell array will typically require 16 SLPM (standard liters per minute) and 27 SLPM for 2 kW. A corresponding volume of purified hydrogen for at least several hours of operation is required in the hydrogen reservoir 35, in addition to the regularly consumed volume of purified hydrogen for processes. The entire backup load of the industrial plant may be one MW or more. Non critical processes are backed up by diesel generator 27 which is started upon receipt of a power failure signal from power controller 13. Interface 29 adjusts diesel output power to appropriate levels. The output of generator 27 goes to power interface 29 which, like power interface 17 may be distributed and provide A.C. power resembling power in the normal feed path 15. Such power is handled in the industrial plant in the same manner as normal power.

Process monitor 31 is a controller that monitors the progress of critical processes and controls the schedule of such processes. During a power failure no new critical processes need be started. On the other hand, ongoing processes, including cassette to cassette processing may continue. Equipment 33 is shown to have an input wafer cassette 34 and an output cassette 36 wherein a batch of wafers is processed usually using the same recipe. When a batch is finished, no new batches are started in order to conserve hydrogen, although the temperature and vacuum conditions of the equipment 33 is maintained for readiness after the power failure.

If hydrogen starts to run low in the hydrogen reservoir 35, the process controller 41 notifies power controller 13 to switch back to backup battery array 19. A graceful shutdown of processes ensues if normal A.C. power has not been restored.

What is claimed is:

1. Backup power method for an industrial plant using hydrogen as a process gas comprising:
providing a fuel cell array arranged to provide backup power to critical processes in an industrial plant;
providing a hydrogen reservoir for use in one or more industrial processes of the industrial plant, the reservoir having a gas storage capacity for operating the hydrogen fuel cell array for at least two hours when providing backup power;
providing a backup battery array arranged to provide backup power to said critical processes in the industrial plant;
providing normal A.C. power to the industrial plant through a power controller that monitors power quality and outputs a power failure signal when normal A.C. power is not available;
switching the power controller from normal A.C. power to battery backup power upon generation of the power failure signal;
starting power generation from the fuel cell array upon generation of the power failure signal, the fuel cell array stealing hydrogen from the hydrogen reservoir; and
switching the power controller from the backup battery array to the fuel cell array so long as backup power is needed and so long as hydrogen is available from the hydrogen reservoir.

2. The method of claim 1 further defined by activating the fuel cell array a preset time after the backup battery array provides backup power.

3. The method of claim 1 further defined by providing backup battery power following the time that the fuel cell array provides backup power.

4. The method of claim 1 further defined by operating a diesel generator to provide backup power to the industrial plant simultaneously with the fuel cell array.

5. The method of claim 1 further defined by monitoring power at a single controller from normal feed power, backup power and the smart meter.

6. A backup power system for an industrial plant using hydrogen as a process gas comprising:
a hydrogen reservoir means supplying gas to a critical industrial process in the industrial plant through a smart meter;
a power controller means for feeding normal power to the industrial process and generating a power failure signal upon failure of normal power feeding;
a fuel cell array connected to the smart meter for stealing hydrogen from the hydrogen reservoir after receipt of a power failure signal from the power controller, the fuel cell array connected to the power controller for feeding backup power to the critical industrial process subsequent to said receipt of the power failure signal.

7. The system of claim 6 further comprising:
a backup battery array connected to said power controller means for feeding backup power to the critical industrial process subsequent to said receipt of the power failure signal and prior to the fuel cell array feeding backup power to the critical industrial process.

8. The system of claim 6 further comprising a process controller means connected to the power controller means for operating critical processes in the industrial plant through said smart meter.

9. The system of claim 6 further comprising a power monitor means for feeding normal and backup power to the critical industrial process, said power monitor means connected to said smart meter.

10. The system of claim 7 wherein said battery array is electrically connected in parallel to said normal power feeding relative to the power controller means.
